(19) United States
(12) Patent Application Publication
(10) Pub. No.: US 2006/0196443 A1
(43) Pub. Date: Sep. 7, 2006

(54) Theme jar-aquarium

(76) Inventors: Debra A. Holms, Germantown, WI (US); Rory J. Holms, Germantown, WI (US)

Correspondence Address: JANSSON, SHUPE, MUNGER & ANTARAMIAN, LTD, 245 MAIN STREET, RACINE, WI, 53403, US

(21) Appl. No.: 11/071,828

(22) Filed: Mar. 3, 2005

(51) Int. Cl. A01K 63/00

(52) U.S. Cl. 119/265

(57) ABSTRACT

A theme jar-aquarium including: a readily-portable container having a bottom wall, a surrounding sidewall, and an open upper end; a cap removably secured to the container and having a topwall with at least one aperture; and at least one theme element non-removably secured to the interior surface. Such theme element can be integrally formed with the container. In certain desired embodiments, an exterior theme element is secured to the outer surface of the jar-aquarium. Also desirable is an embodiment having an exterior handle secured to the sidewall.

### FIELD OF THE INVENTION

This invention relates in general to aquariums for small aquatic animals. More particularly, to readily-portable aquariums characterized by having a specific theme created by theme elements some of which are formed as part of the aquarium or otherwise non-removably secured to the aquarium walls.

### BACKGROUND OF THE INVENTION

Aquariums and viewing tanks that house small aquatic animals are very popular. Due to low maintenance, such small aquatic animals as betta fish or dwarf frogs have become very attractive for homes, offices, classrooms and other small areas. These animals breath air from the surface of the water and do not need any water-aeration equipment. People tried to create an interesting settings inside their aquariums to add more aesthetic value or just for amusement.

It is known that aquarium water is rich with nitrites provided by breakdown product of the fish's metabolism and bacterial breakdown of waste products. The waste aquarium water is found highly beneficial as a fertilizer for house-plants. Aquarium water can be immediately used for watering plants without aging or special preparation. To utilize such valuable quality of the aquarium water, it is desirable to have an aquarium dimensioned for easily lifting by an average person to pour water out of the aquarium directly into a flower-pot. To eliminate risk of a small aquatic animal slipping out with the water, it would further be desirable to have a cap. allowing watering of houseplants while preventing escape of the small aquatic animal.

An aquarium for surface-air-breathing aquatic animals, which is dimensioned and designed to also function as a watering can, may become an easy humorous gift by including a theme composition related to a company profile, a person's hobby or a particular holiday. To allow pouring water out of such theme aquarium without disruption of its theme composition, there is a need for theme elements to be secured with respect to the aquarium body. However, water movement from repeat tilting of the aquarium may cause detachment of the internal theme elements resulting their disorder. Thus, it is desirable to have a non-removable permanent affixing of internal embellishments to the jar-aquarium walls preventing such ornamental elements from being disrupted while pouring water into or out of the jar-aquarium.

### OBJECTS OF THE INVENTION

It is an object of the invention to provide an improved theme jar-aquarium overcoming some of the problems and shortcomings of the prior art, including those referred to above.

Another object of the invention is to provide a readily-portable theme jar-aquarium permitting an average person to pour water out of the aquarium directly into a flower-pot.

Another object of the invention is to provide a theme jar-aquarium having a cap preventing escape of the small aquatic animal while watering houseplants directly from the jar-aquarium.

Still another object of the invention is to provide a theme jar-aquarium having a specific theme formed by a combination of theme-related elements.

Yet another object of the invention is to provide a theme jar-aquarium having a non-removable affixing of the theme elements to the jar-aquarium inhibiting their undesired movement.

How these and other objects are accomplished will become apparent from the following descriptions and the drawings.

### SUMMARY OF THE INVENTION

This invention, which will be described in detail below, is an improvement in aquariums for small aquatic animals of the jar-aquarium type having a specific theme created by theme elements some of which are formed as a part of the aquarium or otherwise non-removably affixed to the aquarium walls.

The present invention provides a theme jar-aquarium featuring a specific theme formed by theme-related elements some of which are non-removably secured to the jar-aquarium. The invention also provides a theme jar-aquarium designed to facilitate pouring water directly from the jar-aquarium into a flower-pot.

The inventive theme jar-aquarium includes: (1) a readily-portable container having a bottom wall, a surrounding sidewall, and an open upper end; (2) a cap removably secured to the container and having a topwall with at least one aperture, the walls together forming an interior surface defining a water-containing volume; and (3) at least one theme element non-removably secured to the interior surface.

A significant aspect of the invention is the non-removable affixing of the internal theme element to the jar-aquarium wall preventing such element from being disrupted while pouring water into or out of the jar-aquarium. Such theme element may be secured to the bottom wall of the container or either side or top walls.

The inventive theme jar-aquarium further includes a plurality of permanently-attached decorative theme-related elements. One of such theme elements is preferably fixed to the bottom wall with the other elements placed on the sidewall and/or the topwall.

In certain embodiments of the invention, the theme jar-aquarium includes a plurality of loose theme-corresponding elements inside the container. Such loose elements could be rocks or shells corresponding with the theme based at least in part on their color.

In certain highly preferred embodiments, the theme jar-aquarium includes an exterior theme element secured with respect to an outer surface of the jar-aquarium. The aquarium walls together are forming such outer surface.

In some instances of the highly preferred embodiments just described, the exterior theme element may be a substantially planar image member or a three-dimensional object secured with respect to the jar-aquarium wall.

Certain preferred embodiments of these invention further include an exterior handle to facilitate lifting and carrying of the theme jar-aquarium. The handle is preferably secured to the sidewall. In particularly preferred form of the invention the handle is integrally formed with the container.

An important feature of this invention involves a cap removably secured to the container. The term “removably secured,” as used herein, means that the cap is tightly fastened to the open end of the container and is held in place when inverted withstanding a pressure of the out-pouring water; and that the cap and the container cam be separated to permit access into the aquarium interior through the open end of the container. Examples of such cap-container connection can be a hitch, threading, snap or frictional (cork type) engagement.

In the most preferred embodiments, the container further has a neck portion forming its open upper end; the cap has a skirt portion extending from the topwall and sized to receive the neck portion. The neck portion and skirt portions have interlocking members. The term “interlocking members” refers to the interengaging parts of the cap-container attachment which secures the cap with respect to the container and allows their repetitive connection and disconnection.

Throughout this summary section and elsewhere in this specification the term “readily-portable” as used herein refers to jars and the like which may be gripped in a hand in order to pour out and replace the water; one-hand portability depends upon size and whether there is a suitable grip, such as the neck or width of the jar and/or a handle to facilitate pouring.

The term “non-removable,” as used in reference to affixing of a theme element means that position of such theme element may not be changed and it can not be separated from the aquarium. In some cases such non-removable affixing may be in a form of a glue, silicon or similar substance uniting the theme element with the jar-aquarium into a monolithic structure or a theme element may be integrally molded with the aquarium wall.

The term “water-stream” as used in reference to free unbroken water-stream passage, means a flow of water pouring directly onto the aquarium from a liquid carrier such as a jug or pitcher, or through a faucet from a reservoir of non-chlorinated water. The term “free,” as used herein, means that the water-stream is entering the container through the cap without aid of any additional device immediately contacting the cap. The term “unbroken,” as used herein in reference to the water-stream, means that the water flow is a continuous line which has no gaps or breaks in it.

### BRIEF DESCRIPTION OF THE DRAWINGS

FIG. 1 is a perspective view of a theme jar-aquarium in accordance with a preferred embodiment of the invention.

FIG. 2 is a perspective view of the theme jar-aquarium of FIG. 1, showing an exterior handle secured to the sidewall.

FIG. 3 is a perspective view of a cap for the theme jar aquarium of FIG. 1.

FIG. 4 is a sectional side view of the cap of FIG. 3.

### DETAILED DESCRIPTION OF PREFERRED EMBODIMENTS

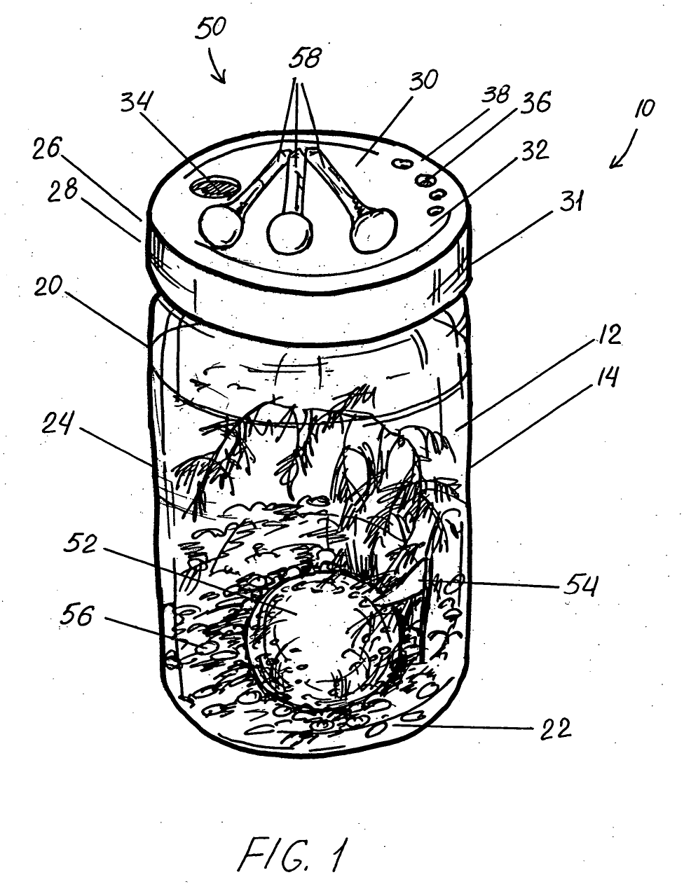

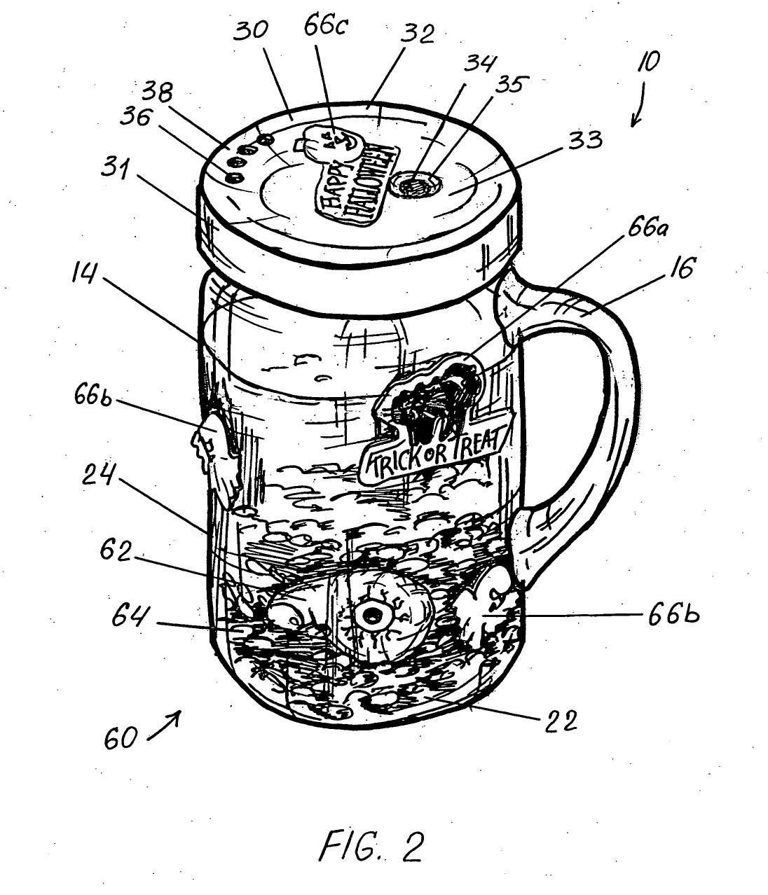

Referring to FIGS. 1 and 2, an inventive theme jar-aquarium 10 includes a readily-portable container 20 having a bottom wall 22, a surrounding sidewall 24, and an open upper end 26 formed by a neck portion 28, and a cap 30 removably secured to the container 20 and having a topwall 32 with an aperture. The walls 22, 24, 26 and 32 together form an interior surface 12 defining a water-containing volume and an outer surface 14.

FIG. 1 shows a possible golfing theme 50 created by internal theme elements as a golf ball 52, a flag-stick 54 and gravel 56, and exterior theme elements such as golf tees 58. Golf ball 52 and flag-stick 54 are an example of non-removably secured theme elements. Golf ball 52 is molded into bottom wall 22 of container 20, thus, cannot be separated from bottom wall 22. Flag-stick 54 is also non-removably fixed to sidewall 24. Golf tees 58 adhered to topwall 32 are just one example of three-dimensional exterior theme elements.

FIG. 2 illustrates another possible theme composition 60 related to Halloween. Composition 60 is formed by an eyeball 62 non-removably affixed to bottom wall 22 and black and/or florescent rocks 64 loosely surrounding eyeball 62. Decals 66 with Halloween related images are examples of substantially planar exterior theme elements completing theme composition 60. Picture of black cat with “trick or treat” message 66a and ghosts images 66b are placed on exterior 14 of sidewall 24. Image 66c of a pumpkin face wishing “Happy Halloween” is adhered to outer surface 14 of topwall 32.

FIG. 2 further illustrates a preferred embodiment of the invention having an exterior handle 16 integral with sidewall 24 of container 20.

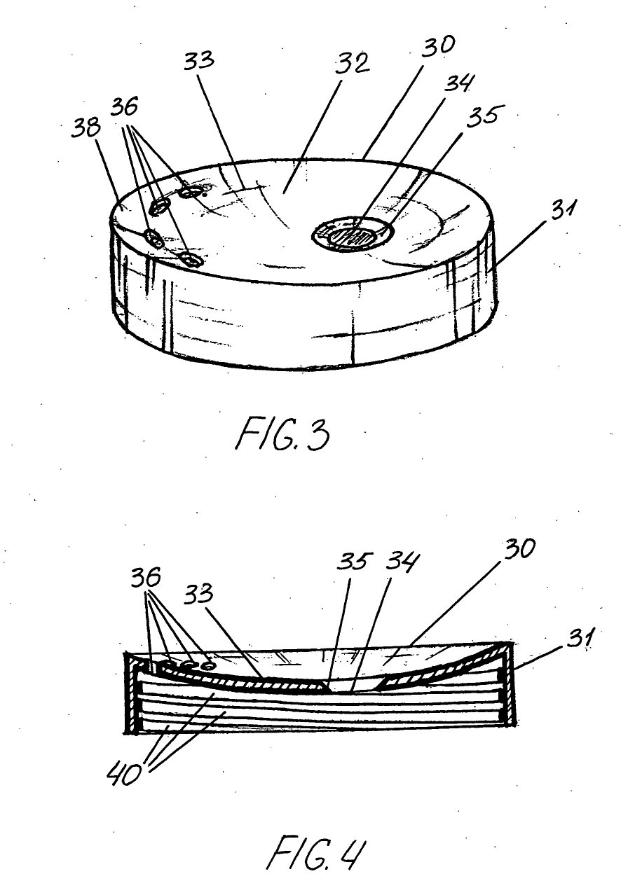

Referring to FIGS. 1-4, the aperture in topwall 32 of cap 30 is an ingress aperture 34 sized to accept free unbroken water-stream passage therethrough for cap-on filling of jar-aquarium 10, and a series of egress apertures 36 smaller than ingress aperture 34 and spaced therefrom to facilitate controlled cap-on out-pouring of water, whereby jar-aquarium water may be changed without removing cap 30. As illustrated on FIGS. 1-4 series of egress apertures 36 are grouped together along an edge 38 of topwall 32.

FIGS. 2-4 show ingress aperture 34 surrounded by a funnel-shaped portion 35 of topwall 32, and topwall 32 having a concave shape 33 to facilitate in-flow of water through ingress aperture 34 into container 20.

Cap 30 further has a skirt portion 31 extending from topwall 32 and sized to receive neck portion 28. Skirt portion 31 and neck portion 28 include corresponding interlocking members 40 which, when interengaged, removably secure cap 30 to container 20. FIG. 4 best shows interlocking members 40 in the form of threading on skirt portion 31.

While the principles of the invention have been shown and described in connection with specific embodiments, it is to be understood that such embodiments are by way of example and are not limiting.

1. A theme jar-aquarium comprising:
a readily-portable container having a bottom wall, a surrounding sidewall, and an open upper end;
a cap removably secured to the container and having a topwall with at least one aperture, the walls together forming an interior surface defining a water-containing volume, the jar-aquarium being adapted for cap-on out-pouring of water; and
at least one theme element non-removably secured to the interior surface preventing such element from being disturbed by the out-pouring of water.

2. The theme jar-aquarium of claim 1 wherein such theme element is secured to the bottom wall.

3. The theme jar-aquarium of claim 1 including a plurality of such theme elements.

4. The theme jar-aquarium of claim 3 wherein one of such theme elements is secured to the bottom wall and a second of such theme elements is secured to other than the bottom wall.

5. The theme jar-aquarium of claim 4 wherein such second theme element is secured to the sidewall.

6. The theme jar-aquarium of claim 4 wherein such second theme element is secured to the topwall.

7. The theme jar-aquarium of claim 1 wherein at least one such theme element is integral with the container.

8. The theme jar-aquarium of claim 1 including a plurality of loose theme-corresponding elements inside the container.

9. The theme jar-aquarium of claim 8 wherein the theme-corresponding elements are rocks or shells.

10. The theme jar-aquarium of claim 1 wherein:
the walls together form an outer surface; and
at least one exterior theme element is secured to the outer surface.

11. The theme jar-aquarium of claim 10 wherein such exterior theme element is a substantially planar image member.

12. The theme jar-aquarium of claim 10 wherein such exterior theme element is a three-dimensional object.

13. The theme jar-aquarium of claim 1 further including an exterior lateral handle to facilitate out-pouring of water through the upper end of the jar-aquarium.

14. The theme jar-aquarium of claim 13 wherein the handle is secured to an exterior of the sidewall.

15. The theme jar-aquarium of claim 14 wherein the handle is integral with the container.

16. The theme jar-aquarium of claim 1 wherein:
the container has a neck portion forming its open upper end;
the cap has a skirt portion extending from the topwall and sized to receive the neck portion; and
the neck portion and skirt portion having interlocking members thereon.
